(19) United States
(12) Patent Application Publication
(10) Pub. No.: US 2009/0135134 A1
(43) Pub. Date: May 28, 2009

(54) EDUCATION METHOD AND SYSTEM INCLUDING AT LEAST ONE USER INTERFACE

(76) Inventors: Iris Jane Prager, Yorktown Height, NY (US); Lisa Jo Oldham, Mason, OH (US); Hugh Ryan De Witte, Dalls, TX (US); Jonathon Phillip Spiller, Dallas, TX (US); Jennifer Danielle Frederick, Dalls, TX (US); Gay Flook Piller, Cincinnati, OH (US); Michelle Jennifer Vaeth, Cincinnati, OH (US); Lela Jo Coffey, Cincinnati, OH (US); Dean Larry DuVal, Lebanon, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/946,409

(22) Filed: Nov. 28, 2007

(51) Int. Cl. G09G 5/00; G06T 15/00

(52) U.S. Cl. 345/156; 345/419

(57) ABSTRACT

An education method and system including a user interface. The user interface may illustrate a portion of the human anatomy that may be viewed in three dimensions. The user interface and method may also provide for selecting training modules, inputting student names, access codes, and tracking pre- and/or post-training student knowledge via quizzes and tests, receive curriculum concurrence from school or government administrators, receive permission from parents or guardians to the actual training and/or provide general visiting users with a holistic overview of the user interface and method of providing the education.

### BACKGROUND OF THE INVENTION

Educating students about puberty has always presented challenges to the educators and other groups interested in providing puberty education. Historically, and even today in some regions of the world, information about puberty education is passed from generation to generation or person to person by word of mouth. Often the “teachers” are not educated themselves with respect to puberty and the content of the education varies greatly. Further, due to the lack of understanding of the scientific basis for puberty and/or social norms, the changes associated with puberty, including physical, psychological and/or other changes may not be presented accurately or at all. This has led, in some cases to the perpetuation of misinformation and/or myths associated with puberty, the changes that are associated with puberty, anatomy, sexual behaviors, etc. For young females especially, the lack of adequate and/or accurate information about puberty can be seriously disadvantageous to their physical wellbeing, psychological wellbeing, comfort and/or hygiene.

In recent years, schools have begun to take a more active roll in providing puberty education. As a result, tools and materials were created to assist in teaching the concepts to a larger class of people at the same time. However, among and within schools, the level of education still varies significantly, often depending on the social and/or economic environment. Thus, there remains little consistency in puberty education and the tools created to help educators do not allow for easy customization of the puberty education programs. Further, the educators often need to obtain approval from parents and/or administrative authorities or governments, requiring significant time and effort on the part of the educator. Together, these shortcomings may led to sub-standard educational practices, which may, in turn, lead to a lower level of understanding among the students.

Specifically, with regard to young female students, the lack of helpful or accurate information related to puberty has, in many cases, led to a fear of the changes associated with puberty, including the onset of menstruation and lack of knowledge about available feminine hygiene products and/or their proper use. For example, two-dimensional graphic illustrations of feminine hygiene products and their use can be difficult to understand or replicate in actual practice leading to improper insertion or use of feminine hygiene products. This, in turn, can lead to fear, discomfort and product failure, especially within the teen and pre-teen population.

It has been found to be beneficial to provide a holistic education and training system that demystifies and accurately presents puberty, menstrual cycle, reproductive cycle, hygiene and/or feminine hygiene products and optionally ancillary topics associated with puberty. Further, it has been found to be beneficial to present the materials in an interactive, multi-media format which may include three-dimensional models. Such information and systems can increase the amount and accuracy of the information that is presented to students and can help them better understand and retain the information provided. Thus, the lives of young men and women can be improved in spite of any social and/or economic boundaries that may otherwise prevent such information from being learned.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A user interface and method uses a computing device that illustrates at least a portion of human anatomy for educational purposes. A user interface may create an illustration of the anatomy that may be viewed in three dimensions. The illustration may display the parts of the anatomy to demonstrate different aspects of puberty, including physical changes. The illustration may be selected, expanded and rotated in three dimensions. A user interface and method may also provide a means for; selecting training modules and optional training modules related to puberty, inputting student names, access codes, and tracking pre- and post-training student knowledge via quizzes and tests, receive curriculum concurrence from school or government administrators, receive permission from parents or guardians to the actual training, and/or provide general visiting users with a holistic overview of the user interface and method of providing puberty education.

### BRIEF DESCRIPTION OF THE DRAWINGS

FIG. 1 is a block diagram of a computing system that may operate in accordance with the claims.

FIG. 2 is a flowchart of a method creating an illustration of the anatomy for educational purposes.

FIG. 3 is an illustration of a user interface for viewing a three dimensional female anatomy illustration.

FIG. 4 is an illustration of a method of displaying additional information related to female education.

FIG. 5 is an illustration of a user interface with additional menu options.

FIGS. 6a-6f illustrate the ability to focus in on an element for additional detail.

FIG. 7 is an illustration of a method of using multi-media to provide puberty education.

FIG. 8 illustrates additional information in the form of providing additional written information.

FIG. 9 illustrates additional information in the form of displaying a second user interface focused on a particular element.

FIGS. 10a-10b illustrate additional information in the form of displaying the same illustration from a different angle.

FIG. 11 illustrates additional information in the form of videos of additional information.

FIG. 12 illustrates additional information in the form of downloads of additional information.

FIG. 13 illustrates additional information in the form of links to additional information.

FIG. 14 illustrates the proper placement of a tampon.

FIG. 15 illustrates the proper placement of an absorbent pad.

FIG. 16 illustrates a method of creating a general user interface.

FIG. 17 illustrates a general user interface.

FIG. 18 illustrates a method of creating a teacher/educator/supervisor mode user interface.

FIG. 19a illustrates a teacher/educator/supervisor mode user interface.

FIG. 19b illustrates a user interface where a guardian selects modules for a user to view.

FIG. 20 illustrates a method of creating a student mode user interface.

FIG. 21 illustrates a student mode user interface.

FIG. 22 illustrates a method of creating a user interface with additional modules.

FIG. 23 illustrates a user interface with additional modules.

FIG. 24 illustrate a method of creating a knowledge level for a user.

FIG. 25 illustrates a user interface for obtaining information used to create a knowledge level for a user.

FIG. 26 illustrates a method of supplying users with requested materials related to the education provided.

FIG. 27 illustrates a user interface a sample user interface for requesting products.

### DETAILED DESCRIPTION OF THE INVENTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

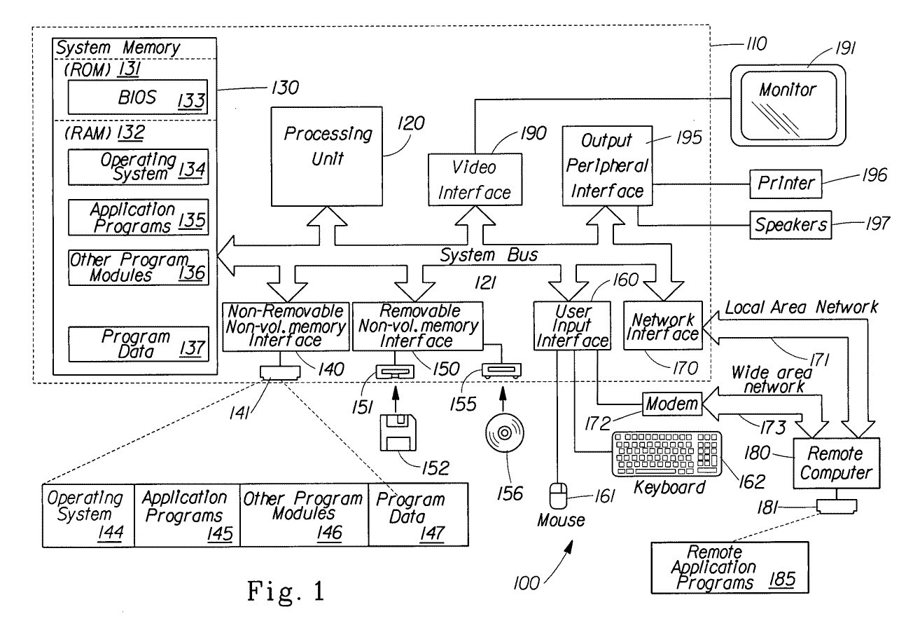

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method, the user interface and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. Computer 110 typically includes a variety of computer readable media. Computer readable media can be any available media that can be accessed by computer 110 and includes both volatile and nonvolatile media, removable and non-removable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

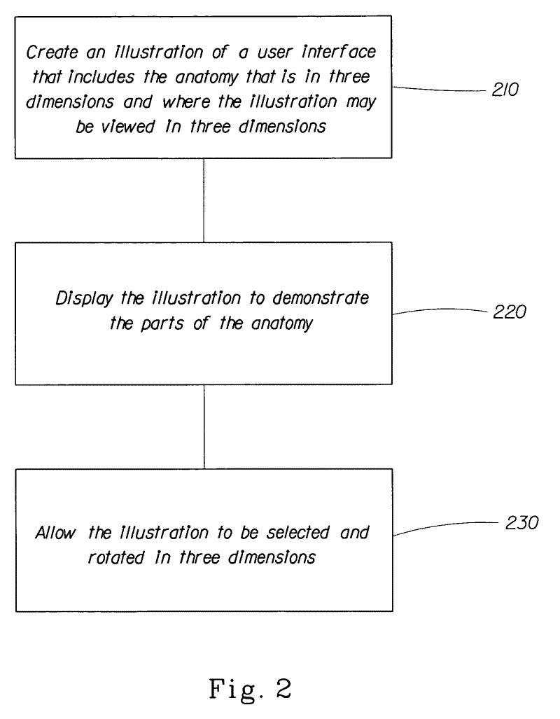

FIG. 2 illustrates a method of creating a user interface on a display in communication with a computing device such as computing device 110, previously shown in FIG. 1, that illustrates human anatomy for educational purposes. The user interface may enable a user or users to perform a series of steps that traditionally would have required a significant amount of searching which may or may not have been successful. Some of the information may not have been available at all and the information may be displayed in an improved manner that makes learning easier and more intuitive.

At block 210, an illustration of a user interface that includes the human anatomy may be created that is in three dimensions and where the illustration may be viewed in three dimensions. By three dimensions, the anatomy may be viewed from the x-axis, the y-axis or the z-axis. In some embodiments, the view may be any combination of the x, y and z coordinates such that the anatomy may be viewed from any angle. The illustration may be stored locally or remotely or a combination thereof. The illustration may be in a variety of electronic formats and may use proprietary or commonly available presentation software.

At block 220, an illustration of a user interface that includes at least a portion of the human anatomy (although non-human anatomy is contemplated and within the scope of the present invention) displayed via a monitor 191, previously shown in FIG. 1. The illustration of a user interface may also be shown via printed materials from a printer 196, via an output peripheral interface 195, or network interface 170, all shown in FIG. 1. Other output means are anticipated including but not limited to; projectors, printed overhead slides, liquid crystal displays, and LED displays.

The illustration of a user interface may be used to demonstrate reproductive anatomy, demonstrate the female reproductive cycle, demonstrate the female menstrual cycle, demonstrate proper insertion of a tampon, demonstrate proper absorbent pad placement, demonstrate how to minimize the risk of toxic shock syndrome, demonstrate how to minimize the risk of being infected by sexually transmitted diseases, demonstrate changes in the anatomy during puberty, demonstrate the changes to the female anatomy during a female reproductive cycle and/or pregnancy, demonstrate the importance of hygiene, etc. (Although the female anatomy, or portions thereof, are shown and described in may instances throughout this specification and the drawings, the descriptions and drawings are in no way intended to limit the scope of the invention to the female anatomy or portions thereof that are described and/or shown. Rather, the description and figures are merely examples and it is contemplated that the anatomy shown and/or described could be male, female, human or non-human.)

At block 230, an illustration of a user interface that includes the anatomy being displayed may be selected by the user and rotated in three dimensions. The selection and rotation of the user interface may be accomplished by a mouse 161, keyboard 162, remote computer 181, remote application programs 185, all previously shown in FIG. 1, or by other anticipated input means, including but not limited to; eye-tracking devices, audio input, touch-screen monitors, and joy-stick controllers.

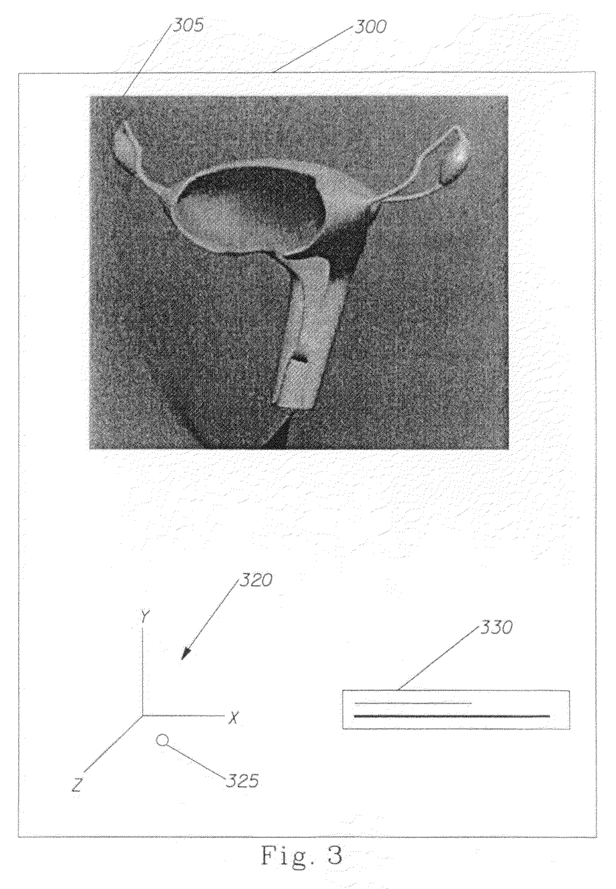

FIG. 3 is an illustration of a possible display of the user interface 300. The illustration 305 may be of the entire male or female anatomy or just certain relevant parts. As previously described, the illustration 305 may be turned and viewed from any of the three dimensions. The illustration 305 may be rotated in a variety of ways. In one embodiment, a user may use a selection device such as a computer mouse 161, previously shown in FIG. 1, to select an item in the illustration 305 and drag the item in the direction to be rotated. In another embodiment, an x, y, z graph 320 may be illustrated and the user may select a point 325 in the x, y, z space to which the illustration 305 should be viewed, thereby rotating the illustration 305. In another embodiment, a user inputs values for x, y and z. Of course, other methods and tools may be used to rotate the illustration 305.

The fourth dimension of time may also be used in the illustration 305, allowing the illustration to change as time passes to illustrate a cycle, such as the aging cycle. For example, the illustration may focus on the changes to the anatomy during puberty and a thirty-second sequence of illustrations may illustrate the anatomical changes that may occur during puberty. The illustration 305 may be stopped during the illustration utilizing a bar or graph as a progression indication 330 and additional information may be obtained on the changes at the point in time at which the sequence of illustrations was stopped.

The user interface 300 may display progression through the female reproductive cycle, pregnancy, menstrual cycle, and/or puberty. The progress indication 330 may take on a variety of forms. In one embodiment, the progress indicator is a bar and progress is indicated by part of the bar moving across the entire bar. In another embodiment, the progress indicator is a circle and progress may be indicated by an indicator traveling around the circle. In another embodiment, the progress indicator 330 may be a symbol such as the female symbol which may fill up with a color as the cycle progresses. The progress indicator 330 may be used to pick a point in a cycle and view the female anatomy at that point in the cycle.

The illustration 305 may be stopped at a point in time and additional information may be obtained about the reproductive system, pregnancy, menstrual cycle, and/or puberty at the stopped point in time. The illustration 305 may be stopped by selecting the progression indicator 330, by right clicking the display or by any other appropriate selection. In addition, a point in time in a cycle may be selected on the progress indicator 330 and the female anatomy may be displayed at the selected point in time. Of course, other embodiments are possible and are contemplated.

As will be explained in more detailed, elements in the illustration may be selected and additional information may be displayed regarding the selected element.

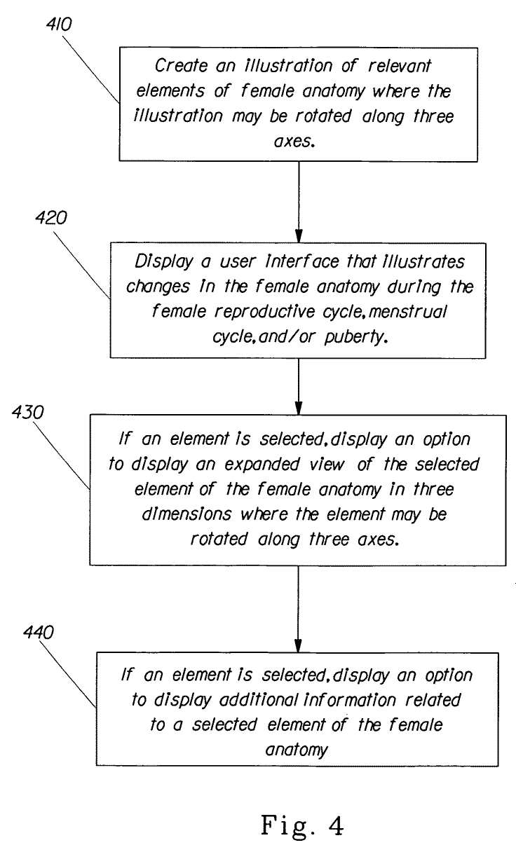

The actual creation of the three-dimensional illustration 305 may occur in a variety of ways. FIG. 4 illustrates one method of creating a computer based user interface for a three dimensional illustration of the desired anatomy. At block 410, an illustration of relevant elements of the anatomy may be created where the illustration may be rotated along three axes. The relevant elements may vary by the purpose of the illustration. For example, if the purpose of the illustration is to demonstrate an aging cycle, virtually all elements of the anatomy may be created. As another example, if the purpose of the illustration is to demonstrate the female reproductive cycle, elements of the female anatomy that are part of the female reproductive system may be created in three dimensions.

The computer applications that create the various user interfaces and methods that interact with the user interfaces may be stored locally, may be stored remotely or a combination of the two. The interface of the illustration may be stored or rendered on demand. The illustration may use commonly available software such as Shockwave player or Windows Media Player or may use proprietary illustration software.

At block 420, the created user interface is displayed to students in a manner that illustrates changes in the anatomy during the female reproductive cycle, menstrual cycle, and/or puberty. The changes may be a time-based progression of how the anatomy changes with time. For example, the cycle may be an illustration of how the female anatomy changes during a traditional 28 day menstruation cycle. As another example, the cycle may be an illustration of how the male or female body changes during puberty. The illustration may be selected by a user and the user may rotate the illustration along three axes.

In execution, the illustration, like any illustration, may be a collection of pixels. As the illustration is in three dimensions, the number of pixels that may be rendered is increased significantly. In addition, as elements may be selected to be enlarged or rotated, the number of pixels required to produce useful moving and expandable illustrations may be very large. However, the results may be especially useful. In another embodiment, algorithms are used to render the selected elements in more detail and to provide the illusion that the elements are rotating.

At block 430, if an element of the illustration is selected, an option may be displayed to display an expanded view of the selected element of the female anatomy in three dimensions where the element may be rotated along three axes. The selected element may be displayed on the same user interface, as an expanded part of the user interface, or in a new user interface.

At block 440, if an element of the illustration is selected, an option may be displayed to display additional information of the selected element of the female. The additional information may be displayed on the same user interface, as an expanded part of the user interface, or in a new user interface.

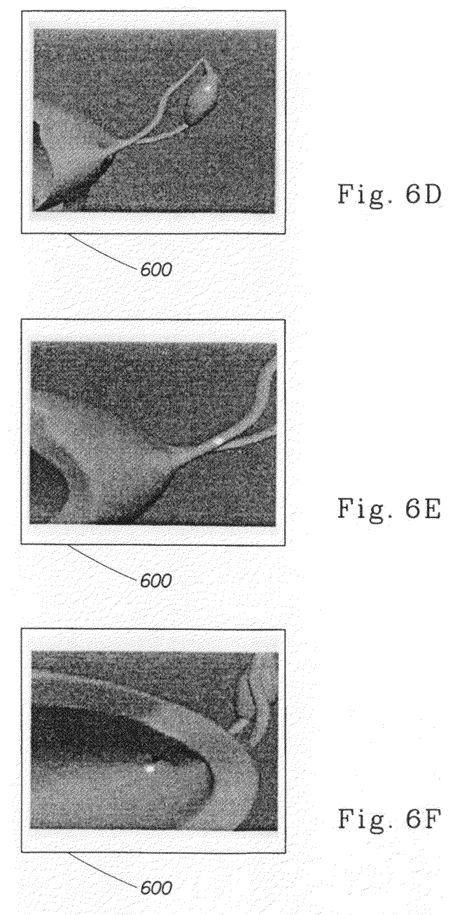

The additional information may take on a variety of forms and types. The form of the additional information may be for example and not limitation, written information, audio files, video files, downloads, links to other information sources, etc. The addition information may be, for example and not limitation, how the selected element is part of the aging cycle, how the selected element is part of the female reproductive cycle or the female menstruation cycle, how the selected elements is part of the male or female reproductive system, digestive system, endocrine system, how the selected element relates to hygiene, etc. In one embodiment, the additional information may include displaying a name of the selected element, a description of the biological function of the selected element and a description of the purpose of the selected element in the reproductive system, during pregnancy, during a menstrual cycle, and/or puberty. FIG. 7, explained later, describes some ways in which the additional information may be displayed.

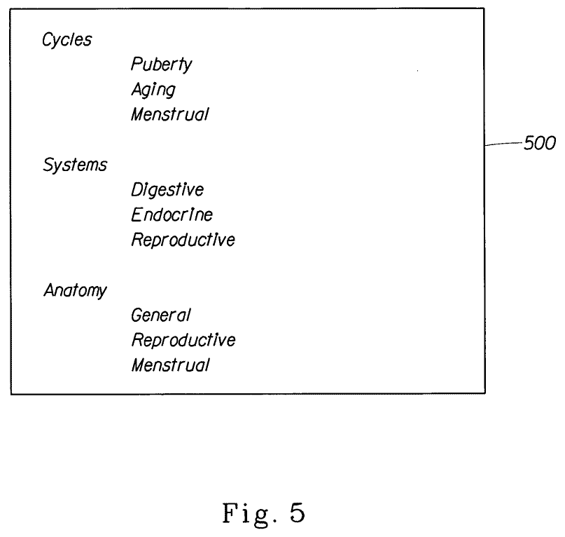

FIG. 5 is an illustration of a possible user interface 500 that allows a user to select to see one or more cycles or one or more biological systems. The unified interface may allow a user to find a variety of information with a minimum amount of searching and typing. Instead of having to wade through endless search results, a technical effect of reducing time spent searching and typing is readily apparent. In addition, as the information is displayed in three dimensions, additional insight may be obtained that might be missed in a two-dimensional illustration.

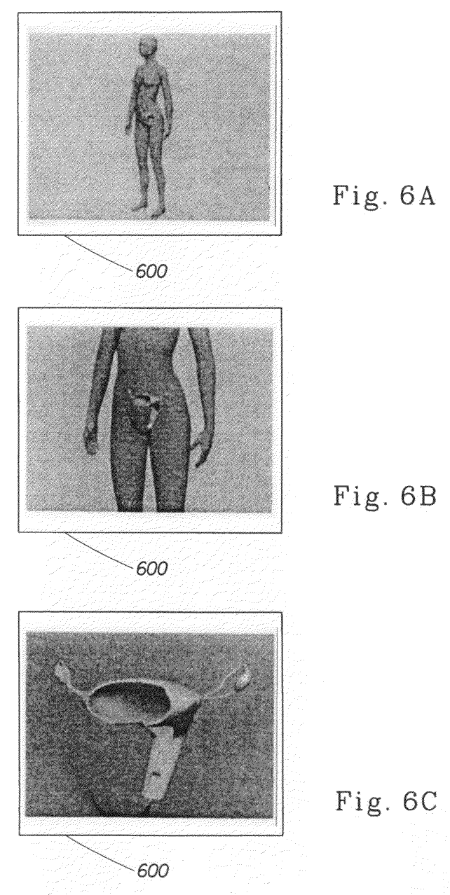

FIGS. 6a, 6b and 6c illustrate one example of how a selected area of the illustration within the user interface 600 may be expanded. In FIG. 6a, the user interface 600 contains an illustration of the entire female body. In FIG. 6b, the user interface 600 enlarges selected female anatomy related to menstruation. In FIG. 6c, the user interface 600 enlarges selected female anatomy related to the release of a human egg. Each of the enlarged illustrations in FIGS. 6a, 6b and 6c may be selected, enlarged, rotated, and additional information may be obtained about each selected element.

In FIG. 6a-6f, the area of interest may be the release of an egg in a female. In FIG. 6a, the user interface 600 may illustrate the general area of the body where an egg is located. In FIG. 6b, the user interface 600 may illustrate in more detail the parts of the female anatomy where an egg may travel with less attention being given to the other parts of the female anatomy. In FIG. 6c, the user interface 600 may illustrate in more detail an egg in an ovary starting to be released and traveling through the fallopian tubes. In FIG. 6d, the user interface 600 may not illustrate any other aspects of the female anatomy beside the specific areas where an egg may travel. In FIG. 6e, the user interface 600 may illustrate an egg traveling through a fallopian tube, a more specific area where an egg may travel. In FIG. 6f, the user interface 600 may illustrate an egg attempting to implant in a uterus. Of course, FIGS. 6a-6f are just examples and not intended to limit the scope of the present invention. Other illustrations of cycles such as aging or puberty cycles are possible and are contemplated. Related, the illustration(s) may be of any part(s) of the male or female anatomy and not just the female reproductive anatomy.

Elements of the illustration may be highlighted as the user interface progresses to illustrate the changes during the female reproductive cycle, the menstrual cycle, and/or puberty. In one embodiment, the user interface illustrates the changes to the female reproductive anatomy during pregnancy. In another embodiment, the user interface illustrates the affects of toxic shock syndrome on the female anatomy. In yet another embodiment, the user interface illustrates the effect of emotions and hormones on the anatomy. In another embodiment, the user interface illustrates how hygiene products assist users.

FIG. 7 illustrates a method of creating a computer-based user interface that illustrates certain portions of the anatomy for educational purposes using a variety of multimedia technologies in more detail.

At block 710, an initial illustration of the reproductive anatomy is displayed in three dimensions. By three dimensions, the illustration may be viewed from the x, y and z perspective and in some embodiments, the illustration may be rotated along any of the perspectives.

At block 715, if an element of the illustration is selected, additional information may be displayed in a variety of multi-media forms such as described in blocks 720-770. For instance, in one embodiment, shown at block 720, additional textual information about the selected element may be displayed. The selection may be made with a computer mouse 166, shown previously in FIG. 1.

In another embodiment, shown at block 730, the view of the selected element may be expanded, thereby showing the selected element in more detail. This capability increases focus on an area of interest, or on an area that relates more specifically to a particular lesson plan. This selection may also be made with a computer mouse 166, shown previously in FIG. 1. As was illustrated previously in FIGS. 6a-6f, the element may be enlarged through a series of displays.

In another embodiment, shown at block 740, the selected element may be viewed separately and rotated in three dimensions such that the element may be viewed from a plurality of angles.

In another embodiment, shown at block 750, video content related to the selected element may be provided as additional information. The video content related to the selected part may be stopped, paused, skipped, fast forwarded and rewound.

Another embodiment may be, shown at block 760, to execute an audio files containing content related to the selected element. The audio content related to the selected part may be stopped, paused, skipped, fast forwarded and rewound.

Another embodiment may be, shown at block 770, to display an option to link to additional information about the selected element. The links may lead, for example, to additional information to male and/or female hygiene product supplier network sites or about male and/or female hygiene products related to the part selected.

Of course, block 720-770 are simply examples, not limitations and additional functions are possible and are contemplated. At block 780, when any of blocks 720-770 are complete, if the part of the illustration is unselected, the initial illustration may be displayed.

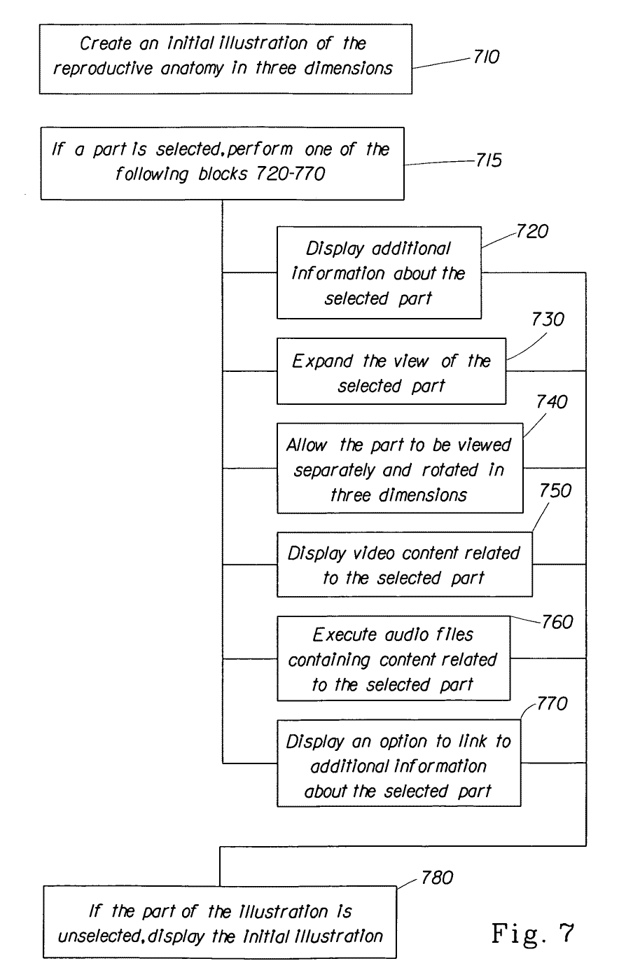

FIG. 8 is an example of a sample illustration of the embodiments described in FIG. 7. For instance, the additional information may be displayed as a pop-up window 810 that may appear to provide textual or audio information 820 and/or graphic information 830. A pop-up user interface 810 may appear that provides a common name for the selected element or elements, a scientific name, and a brief description of the function the selected element plays in female aging or its biological function in a variety of cycles. These are all examples of additional information that may be presented in textual or audio format.

The additional graphic information 830 may be in the form of a drawing, picture, graph, video illustration, or other appropriate file. As indicated previously in FIG. 7, the selection of the additional information as demonstrated by the pop-up window 810, may be made with a computer mouse 166, shown previously in FIG. 1, or by simply rolling an input device over the elements on the display. Some elements may illuminate to indicate additional information is available about the elements. As with most displays, the information being displayed may be printed, saved, emailed or communicated in virtually any manner.

The display of additional information 810 may be an overlay user interface where a larger and more detailed version of the selected part is displayed in the overlay. The selected element in the overlay may be viewed separately and rotated in three dimensions such that the part may be viewed from a plurality of angles and a user may select to rotate and stop the rotation of the part using an input device.

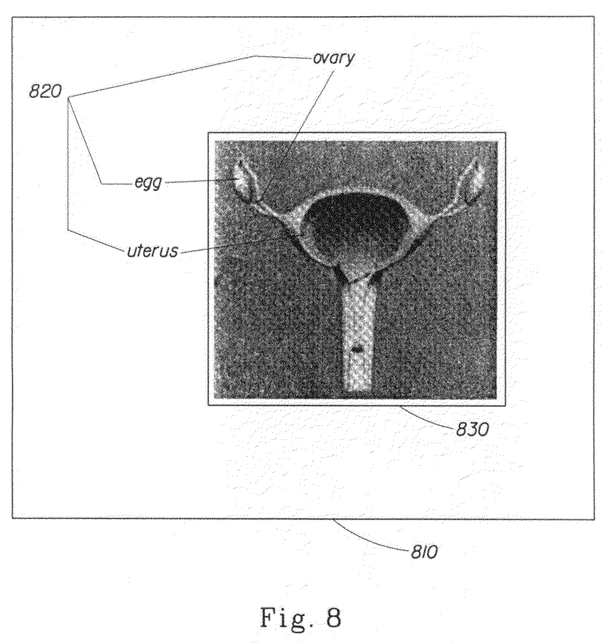

FIG. 9 is an illustration indicated how a selected element from an illustration displayed in the main user interface 900 may be displayed in a graphic pop-up window separate from the main illustration. Specifically, the illustration displayed in the main user interface 900 contains a female uterus, fallopian tubes and ovaries. As the computer mouse 166, shown previously in FIG. 1 is scrolled over one of the ovaries, a pop-up window 910 appears as a separate illustration showing a close up of the ovary and of an egg being released by the ovary so that it is free to travel down the fallopian tube to the uterus. The illustration in the pop-up window 910 may also be rotated and manipulated.

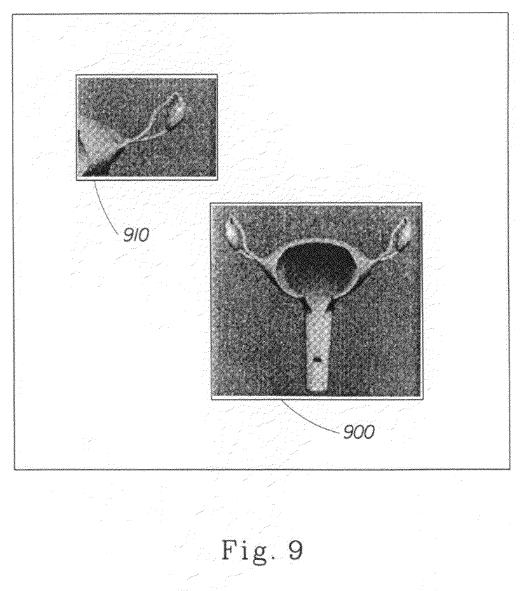

For example, FIG. 10a may illustrate elements of the female anatomy from a first angle as the elements appear in the pop-up window 910, shown previously in FIG. 9. FIG. 10b may illustrate the same elements within the pop-up window from a second angle after being rotated and/or manipulated by the user. The ability to rotate the illustration may save a user a significant amount of time searching for illustrations from different angles. In addition, education may be improved by viewing the illustration from a variety of angles.

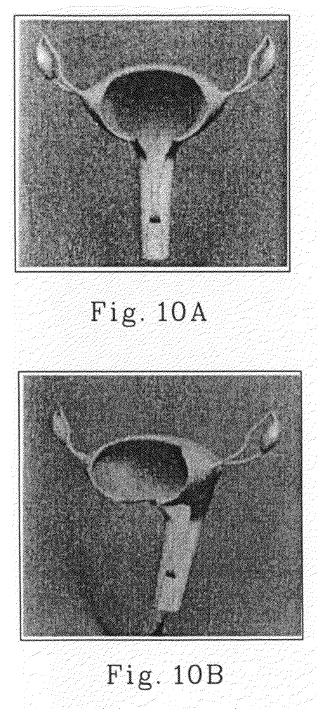

FIG. 11 illustrates an example of how a graphic pop-up window 1100 may be used to display additional information, such as a video, as described previously at block 750 of FIG. 7. The video may explain a function or changes of the selected part in a female cycle, such as the female reproductive cycle, female endocrine system or the female growth cycle. This same illustration may also illustrate an example of how a graphic pop-up window 1100 may be used to display additional information, such as an audio file containing content related to the selected element, as previously described at block 760 of FIG. 7. The video or audio content related to the selected part may be stopped, paused, skipped, fast forwarded and rewound.

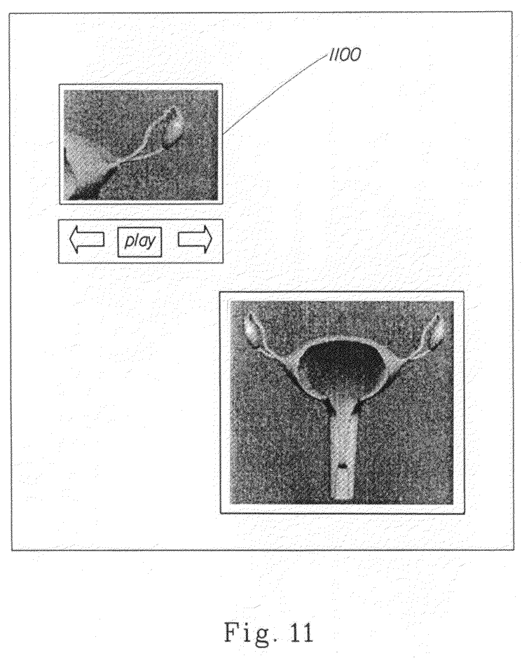

Based on student questions or dialog, the teacher may have a need to access additional downloadable files, either video or audio in format, that may provide information on related topics. Examples include puberty or pregnancy cycles, audios regarding hormones, emotions, or other physical changes to the body. This need may be addressed through the embodiment shown in FIG. 12 showing a pop-up illustration on the main user interface 1200. In addition to a pop-up window showing a part of the anatomy of interest, links downloads 1210 of either video 1220 or audio 1230 downloadable files are also displayed. The user can download any of these additional files by selecting with an appropriate input device, such as a computer mouse 161, as previously shown in FIG. 1. These optional links were previously called out at block 770 of FIG. 7 and are similar to the textual pop-ups at block 820 previously illustrated in FIG. 8.

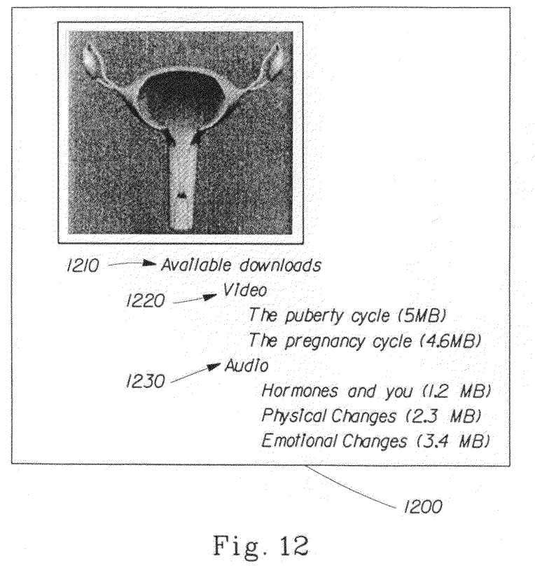

To facilitate addition discussions with students, encourage independent study, or to point out additional resources that may help individual students, there may be a need to access additional information through internet URL links. FIG. 13 illustrates possible URL links 1300 that provide additional information on a related topic. Other URL links 1310 may be lead to feminine hygiene product supplier network sites or about feminine hygiene products.

These links are important as adolescents going through puberty have a difficult time learning about, properly using, and developing confidence in the effectiveness of feminine hygiene products. It is contemplated that these links may also be complimented by illustrations or video files demonstrating proper use of these products.

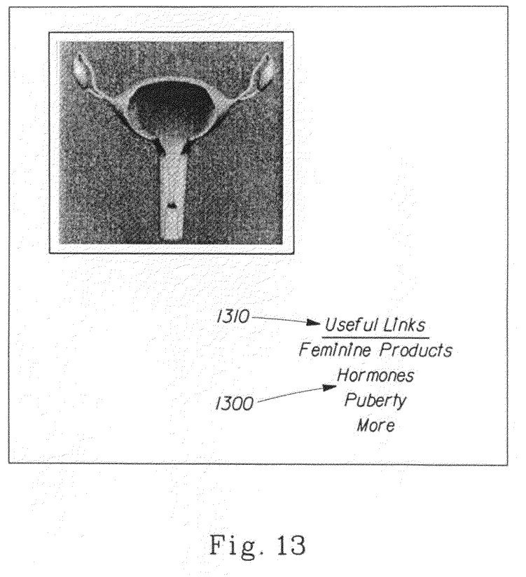

FIG. 14 is a possible illustration of how a 3-dimensional image or video file 1400 could be used to demonstrate proper insertion and positioning of a tampon 1410 within the body. The user interface 1420 may include a series of drawings, a video illustration, or other graphic file intended to improve the accurate use of this product.

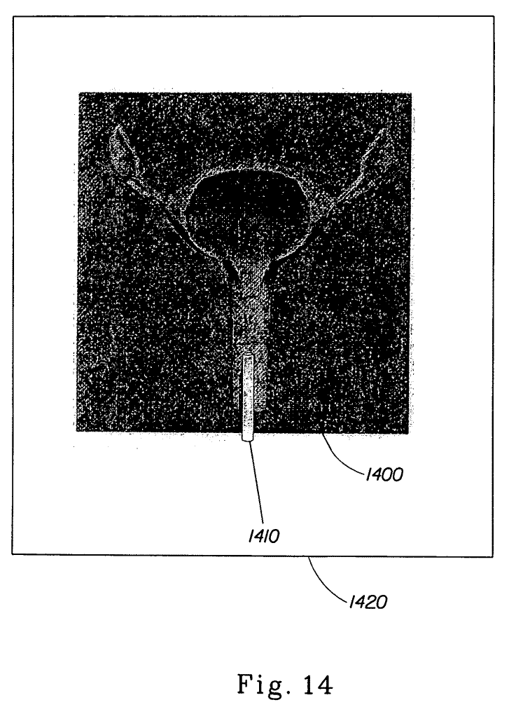

FIG. 15 is a possible illustration of how a 3-dimensional image or video file 1500 could be used to demonstrate proper positioning of a feminine hygiene pad or liner 1510 on a panty, and subsequent positioning of the pad or liner next to the female genital region of the body as part of a user interface 1520.

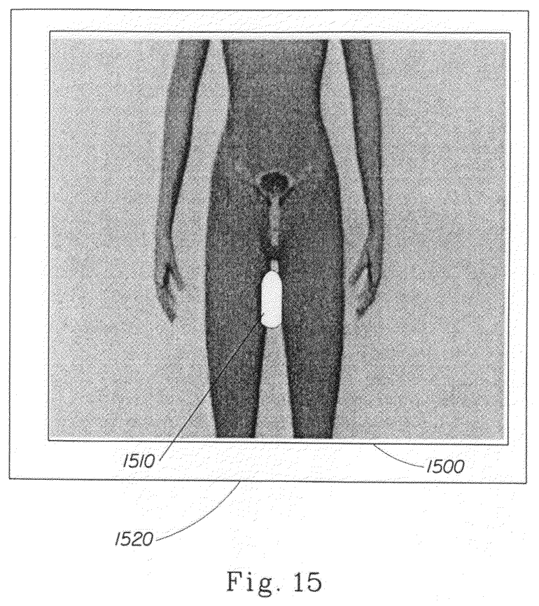

FIG. 16 illustrates a method of creating a general user interface that all users would first access as they start to use a computer-based user interface that illustrates a desired portion of the anatomy for educational purposes. At block 1610, an initial interface is provided that allows the user to identify themselves as a visitor interested in a tour of the site, a visitor interested in receiving more information regarding the site, an educator interested in registering with the site, an educator already registered with the site and interested in accessing a variety of user interface functions, a school administrator interested in reviewing the planned curriculum, a parent interested in reviewing the planned curriculum and/or providing permission for their child to receive the education, or a student interested in accessing a variety of user interface functions. Other options are possible and are contemplated within this general user interface.

If a user identifies oneself as a visitor interested in a tour of the site, another user interface 1620 is provided wherein a tour of the site is provided. This tour could be a video overview, a series of illustrations, an audio overview, or a combination of multi-media content intended to give the visitor a general overview of the site and communicate the overall benefits of the system for the education of students on puberty via additional user interfaces 1680.

If a user identifies oneself as a visitor interested in additional information, another user interface 1670 is provided wherein the visitor can request information and provide appropriate contact information, or can access contact information of the program owner or provider via additional user interfaces 1680.

If a user identifies oneself as an educator, another user interface 1630 is provided wherein the educator can register as an educator by providing appropriate contact and school information, or if previously registered, can log-on to access other user interfaces associated with the puberty education system via additional user interfaces 1680.

If a user identifies oneself as an administrator, another user interface 1640 is provided wherein the administrator can input log-in information provided to them by the educator. Once logged in, the administrator may review the planned curriculum and provide concurrence for their respective school system via additional user interfaces 1680.

If the user identifies oneself as a parent, another user interface 1650 is provided wherein the parent can provide log-in information provided to them by the educator. Once logged in, the parent may review the planned curriculum and provide concurrence for their respective child via additional user interfaces 1680.

If the user identified oneself as a student, another user interface 1660 is provided wherein the student can provide log-in information provided to them by the educator. Once logged in, the student can access a variety of user interfaces 1680 including but not limited to a 3-dimensional anatomy illustration, pre and post education testing, sample information, and a range of optional modules or links to additional information. When a user signs in, the system may track the progress of the user through the various displays. The progress of the user is stored such that when the user returns to the user interface, the user may return to the location at which the user left the user interface. In addition, the progress of a user may be tracked through the individual units.

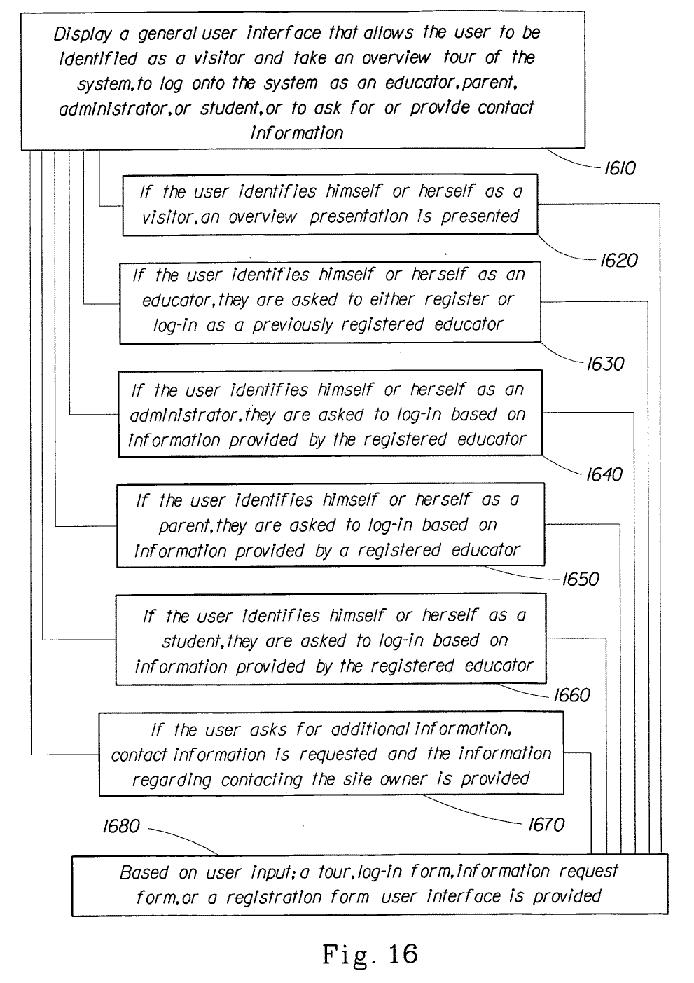

FIG. 17 is an example of a sample general user interface illustrating embodiments described in FIG. 16 of a general user interface.

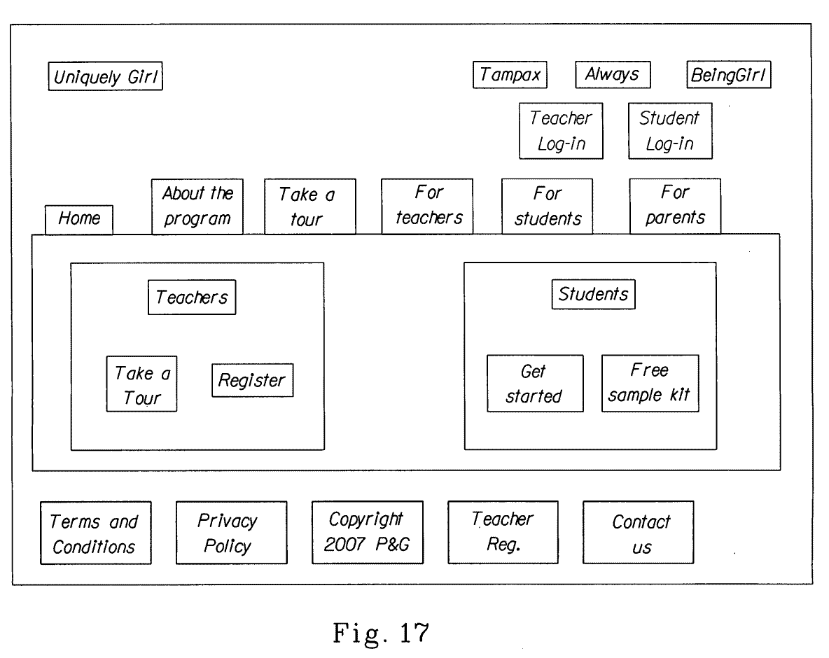

In another embodiment, the user interface may have a teacher/educator/supervisor mode and a student mode. FIG. 18 may illustrate a method of creating teacher/educator/supervisor mode user interface. At block 1810, a user interface may be displayed that lists available educational modules related to puberty. The educational modules may be separated by topic, by user age, by user module or may be tailored to individual users.

At block 1820, a teacher, educator or supervisor may be permitted to select the education modules to be part of an education about puberty for a user. The modules may vary according to a variety of factors. Some modules may share very basic information and may just introduce general topics. Other modules may be more detailed and scientific. The modules may be based on topics such as puberty, aging, the reproductive system, pregnancy, etc. The modules may also be biologically based on the function of elements of the anatomy at various stages or in various cycles. The modules also may be all age based, grade based or based on norms as outlined by a school district or other authority such as local government, state government and national governments. The modules may have many parts that take months to complete or may be quick blurbs on a single topic. As can be understood, the modules may be virtually limitless in what they cover.

At block 1830, the selected educational modules may be stored in a memory in the computing device. In one embodiment, the computing device is a local device and in another embodiment, the computing device is remote from the user. At block 1830, the user interface may also allow an administrator to load data into the computing device. The data may include student log-in names or identification codes, student log-in names or identification codes and modules for the student to review.

In some embodiments, before the education modules are made available to students, permission or authorization for the education may be collected from parents or guardians, represented by block 1840. The user interface may allow the supervisor to also communicate a topics list and/or a glossary of anatomical terms used in the selected modules to parents or guardians. The user interface may allow the supervisor to communicate an invitation to users to view the selected modules. In addition, the user interface may allow the supervisor to communicate a topics list and/or a glossary of anatomical terms used in the selected modules in an invitation to users.

At block 1850, the education modules are made available to the students. In some embodiments, the modules are made available to an entire class. In another embodiment, an additional module may be added to specific members of a class. The decision on the modules to be presented may be dynamic depending on the answers provided. Further discussion of the dynamic adjustments is provided.

At block 1860, data related to the use of the modules by the users may be stored. In one embodiment, the teacher, educator or supervisor receives reports about the progress of the users through the modules. In addition, the teacher, educator or supervisor may receive reports about user's grades on quizzes in the modules. The reports may analyze user grades on quizzes in the modules and determine modules that need additional emphasis based on the quiz grades. The reports may include data on the users, data on the time spent on the modules, data on the correct answers to the quizzes in the modules and data on questions asked by the users. Further, a user interface may be provided for an administrator, guardian, or student to submit questions and the supervisor may provide responses.

In addition, at block 1870, a user interface may be provided for the teacher, educator or supervisor wherein they may be able to request products from a list of available products. The products may be free samples or could be samples purchased electronically.

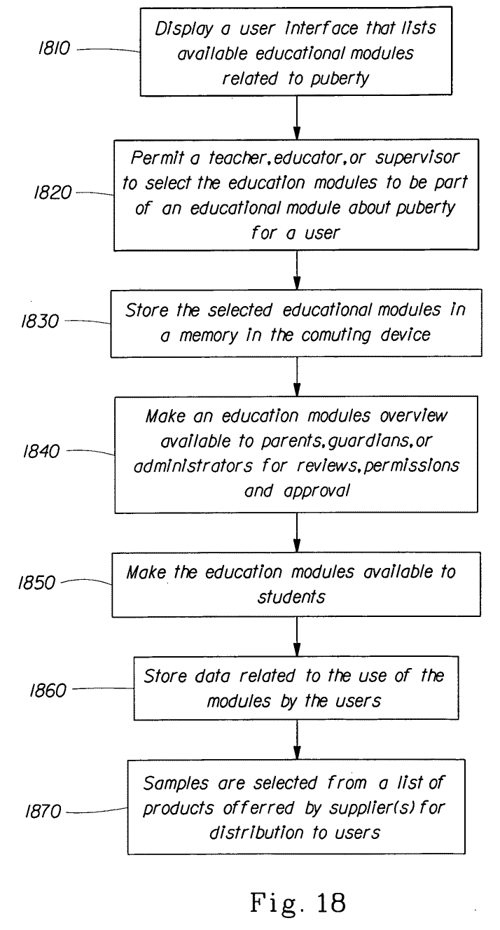

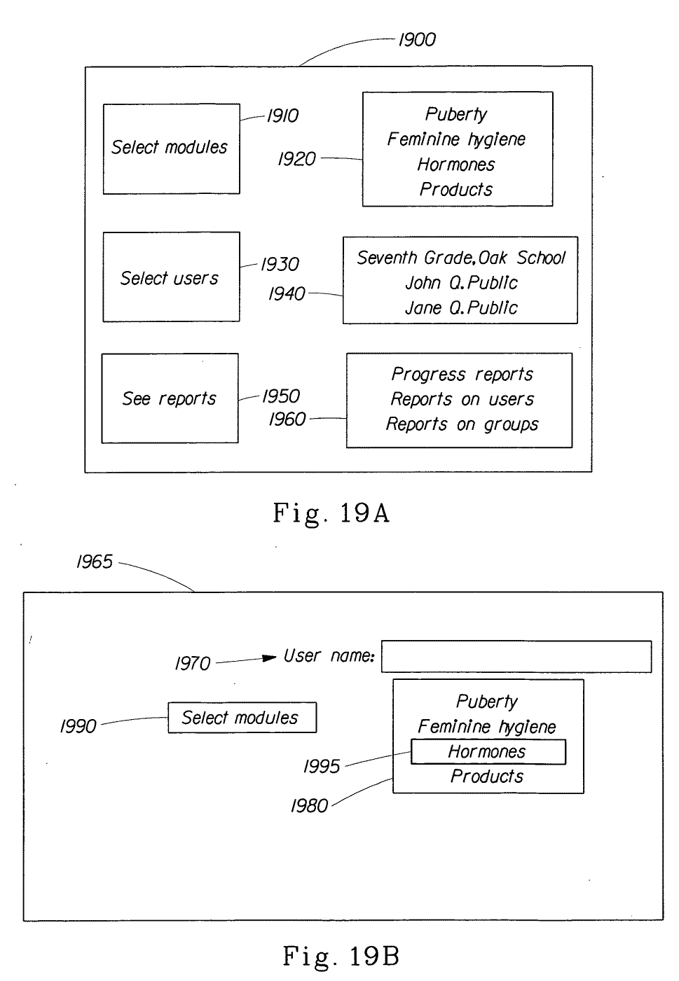

FIG. 19a may be an illustration of a teacher, educator or supervisor user interface 1900. A teacher, educator or supervisor may select the education modules 1910 to be part of an education about puberty for a user. The modules selected 1920 may vary according to a variety of factors.

The user interface 1900 may allow the teacher, educator or supervisor to select users 1930 or communicate an invitation to users 1940 to view the selected modules. In addition, the user interface 1900 may allow the teacher, educator or supervisor to communicate a topics list and/or a glossary of anatomical terms used in the selected modules in an invitation to users.

The user interface 1900 may also allow an administrator to load data into the computing device. The data may include student log-in names 1940 or identification codes, student log-in names or identification codes and modules 1920 for the student to review.

The user interface 1900 may allow data related to the use of the modules 1920 by the selected users 1930 to be stored. In one embodiment, the teacher, educator or supervisor receives reports 1950 about the progress of the users 1940 through the modules 1920. In addition, the teacher, educator or supervisor may receive reports 1950 about user's 1940 grades on quizzes in the modules. The reports 1960 may analyze user grades on quizzes in the modules and determine modules that need additional emphasis based on the quiz grades. The reports 1960 may include data on the users 1940, data on the time spent on the modules 1920, data on the correct answers to the quizzes in the modules 1920 and data on questions asked by the users 1940. Further, a user interface 1900 may be provided for an administrator, teacher or educator to receive questions from users and the superior may provide responses. It is further contemplated that an interface analogous to the user interface 1900 could be used by teachers, educators or supervisors to submit questions to the program administrator and the program administrator may provide answers to the questions presented.

FIG. 19b is an illustration of a user interface 1965 for soliciting approval from a guardian or caregiver that an adolescent may review and grant approval for the adolescent to view the various modules. For example, the guardian or caregiver may input a student's name 1970. The name may be typed or selected from a drop down list. Next, a list of modules 1980 may be displayed and the guardian or caregiver can view the content of the modules 1980 and select the modules 1990 that the guardian or caregiver grants permission for a student 1970 to view. In addition, some modules may be highlighted 1995 as being modules recommended for the user 1970. Of course, additional detail may be obtained about each module and individual elements within each module may be selected or unselected. The level of selection (i.e., entire module, element in module, word in element of module) is variable.

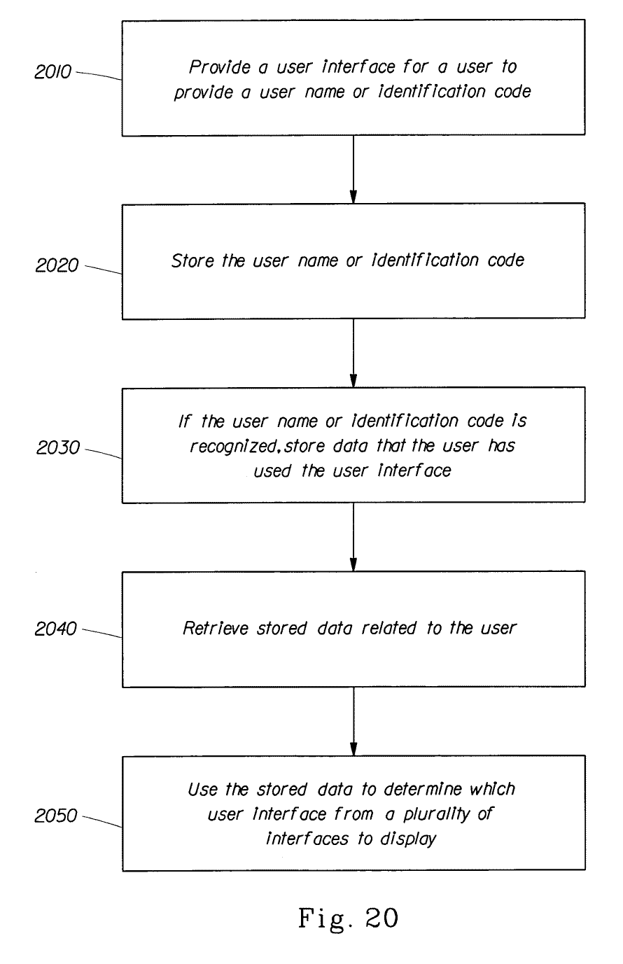

There may be a separate user interface for users. FIG. 20 is an illustration of method of creating a user interface with a student mode that illustrates female anatomy for educational purposes. At block 2010, a user interface may be provided for a user to provide a user name or identification code.

At block 2020, the user name or identification code may be stored. If the user information is to be tracked by a supervisor, then user information may need to be communicated to a central storage location such that the progress may be tracked. In another embodiment, the user identification may be stored locally and communicated periodically to a user tracking system.

At block 2030, if the user name or identification code is recognized, data may be stored that the user has used the user interface. The data may be stored locally or remotely. If the data is stored locally, it may be periodically communicated to a user tracking system. The data may indicate the process of the student through the lesson, the percentage of questions answered correctly, etc.

At block 2040, stored data may be retrieved related to the user. In this way, the user may start where they left off and not be forced to repeat questions. In addition, if the supervisor has created any messages for the user, these may be communicated. Further, if analysis of previous answers indicates an area where knowledge could be improved, additional instruction may be added in these areas. Of course, the data may be used for a variety of purposes.

At block 2050, the stored data may be used to determine which user interface from a plurality of interfaces to display where the displayed interface relates to the interface the user last used. The user interfaces may relate to educational modules and the user interfaces may be specific to specific modules. A level of guardian permission may be in the stored for the user and only user interfaces may be displayed that the user has guardian permission to view. For example, a guardian or teacher may select which user interfaces the user will be able to view. If the user name or identification code is not recognized, the user may be allowed to proceed as a guest or register as a new user. If the user is a new user, guardian information may be obtained from the user such that permission to view additional interfaces may be obtained from the guardian.

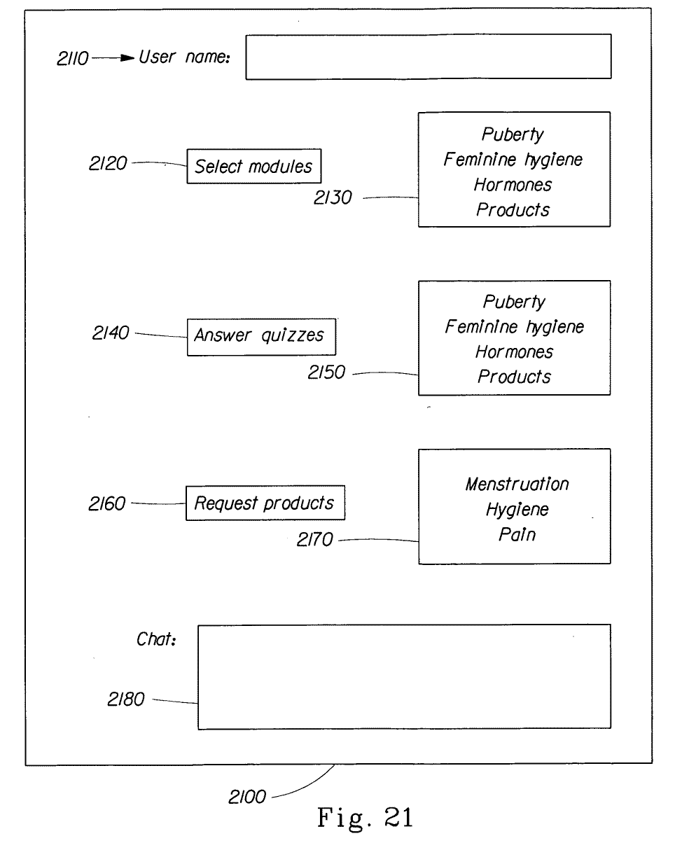

FIG. 21 is an illustration of an example of a user interface 2100 for a student. The user name 2110 may be assigned by a supervisor or may be created by the user. If the user name 2110 is chosen by a student, then the student may need to provide additional information such that a supervisor may oversee the student. The user name or identification code 2110 may be stored. If the user information 2110 is to be tracked by a superior, then user information may need to be communicated to a central storage location such that the progress may be tracked. In another embodiment, the user identification 2110 may be stored locally and communicated periodically to a user tracking system.

The stored data may be used to determine which user interface 2100 from a plurality of interfaces 2100 to display where the displayed interface relates to the interface the user last used. The user interfaces 2100 may relate to educational modules 2120 and the user interfaces 2100 may be specific to modules 2120. A level of guardian permission may be in the stored for the user 2110 and user interfaces 2100 may be displayed that the user has guardian permission to view. For example, a guardian or teacher may select which user interfaces 2100 the user will be able to view. If the user name or identification code is not recognized, the user may be allowed to proceed as a guest or register as a new user. If the user is a new user, guardian information may be obtained from the user such that permission to view additional interfaces may be obtained from the guardian.

If the user 2110 was directed to the user interface 2100 by a guardian or teacher, the progress of the user 2110 through user interfaces regarding puberty education may be stored and when the user 2110 ends the session, the user progress may be reported to the guardian or teacher.

The user interface 2100 may allow a user to select modules to view 2120. The list of modules 2130 may be limited by the permissions granted by the superior. The user also may be able to answer quizzes 2140 selected from a list of quizzes 2150. The quizzes may be required to proceed to the next user interface. In addition, a user 2110 may be able to request products 2160 from a list of available products 2170. The products 2170 may be free samples or could be samples purchased electronically.

In some embodiments, the user interface 2100 may contain a chat bar 2180 where a user may submit questions or comments while viewing a user interface 2100. The chat bar 2180 may communicate the questions or comments to a network and the question or comments may be responded to by a guardian, a teacher or someone trained in puberty education. This data also may be stored to improve future versions of the user interface. In some embodiments, the users may chat with each other in a chat bar on the user interface 2100. In certain embodiments, the chat bar on the interface 2100 could be used by teachers, educators and/or supervisors to communicate with each other or to submit questions to the administrator of the program and the program administrator may monitor and/or participate in the chat with the teachers, educators and/or supervisors.

In addition, in some embodiments, other users may view the same user interface 2100 at the same time. In this way, a teacher may walk a class through all the screens at the same time and be sure that all the students are looking at the same page.

As with any educational program, the user interface 2100 may ask questions of users related to the female reproductive system and the answers to the questions may be stored and graded. The question may be related to the menstrual cycle, the endocrine system, hygiene, toxic shock syndrome, sexually transmitted diseases, etc. The answers and grades of the answers may be communicated to a guardian or a teacher.

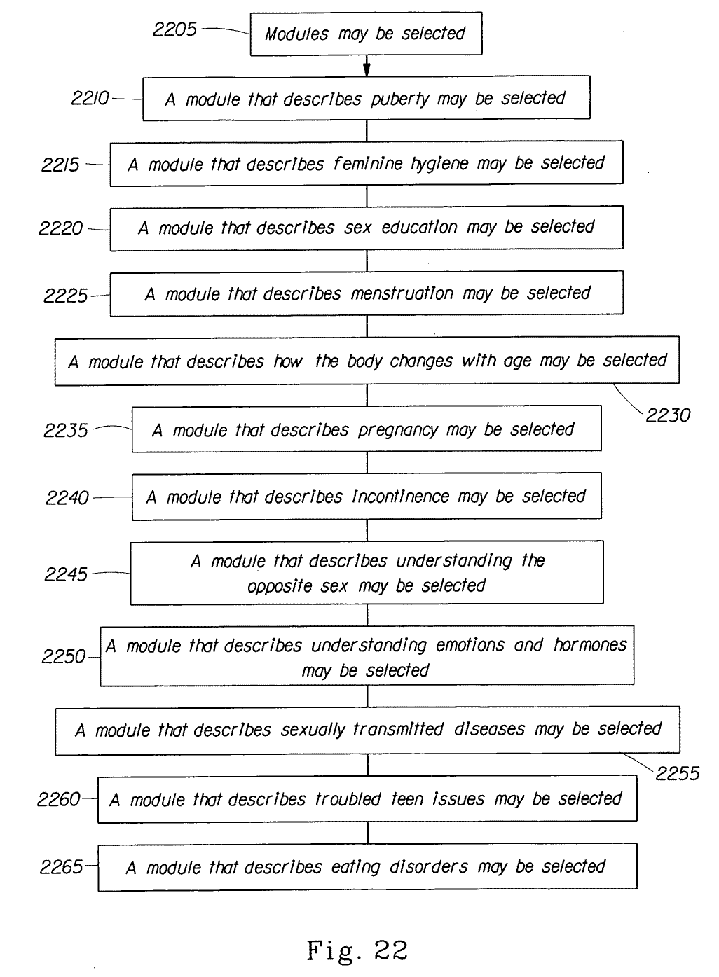

FIG. 22 may illustrate additional modules that may be displayed on a menu to both superiors and to students. The superiors may choose to include additional modules and student may choose to take part in additional modules.

At block 2200, a module containing a list or menu of modules may be displayed and selected 2205. The modules may have a specific user interface and may cover a variety of topics that may be related to the aging process, in particular, the puberty process. There may be a list of available modules and related user interfaces. One module 2210 that may be selected may be specifically devoted to the subject of puberty. This module 2210 may focus on a variety of areas of puberty, from physiological changes to psychological changes. A second module 2215 that may be selected may be devoted to hygiene. Again, the area of hygiene is broad and the coverage of the module may be adjusted on a variety of factors such as the age and/or sex of the intended audience, the knowledge of the intended audience, the wishes of the local school district, etc. The modules may be downloaded and saved such that the modules may be viewed at a point in the future and such that the module may be viewed repeatedly.

Additional modules may cover a variety of areas. By way of example and not limitation, the additional modules that may be selected may cover sex education 2220, menstruation 2225, describing how the body changes with age 2230, describing pregnancy 2235, describing incontinence 2240, describing understanding the opposite sex 2245, describing emotions and hormones 2250, describing sexually transmitted diseases 2255, describing troubled teen issues 2260 and educational module to be used to describe eating disorders 2265. Of course, other modules are possible and are contemplated.

The modules 2205 may be in a variety of formats. For example, in one embodiment, the education module used to describe body changes with age 2230 is a multimedia presentation of different stages of body development over time and how the changes relate to puberty. The multimedia presentation may be downloaded for later execution and the multimedia presentation may illustrate the progress through the presentation. Similarly, the education module used to describe pregnancy 2235 may be a multimedia presentation of different stages of body development while pregnant over time and how the changes relate to female reproduction. Again, the multimedia presentation may be downloaded for later execution and the multimedia presentation may illustrate the progress during the presentation.

The education module used to describe incontinence 2240 further includes a multimedia presentation of understanding about female incontinence at different events and points in life and how understanding incontinence relate to puberty, menstruation, reproduction, menopause, and general aging. The multimedia presentation may be downloaded for later execution and the multimedia presentation may illustrate the progress through the presentation.

The education module used to describe understanding members of the opposite sex 2245 further includes a multimedia presentation of understanding members of the opposite sex at different events and points in life and how understanding members of the opposite sex relate to puberty, menstruation, and/or reproduction. The multimedia presentation may be downloaded for later execution and the multimedia presentation may illustrate the progress through the presentation.

The education module used to describe emotions and hormones 2250 may include a multimedia presentation of emotions and hormones at different events and points in life and how the emotions and hormones relate to the reproductive system, pregnancy, the female menstrual cycle, and/or the endocrine system. The module 2250 may also include a description of emotions and hormones at different events and points in life and how the changes relate to puberty, reproduction, menstruation, and/or maturation. Logically, the multimedia presentation may be downloaded for later execution and the multimedia presentation may illustrate the progress through the presentation.

The education module used to describe sexually transmitted diseases 2255 also may include a multimedia presentation of sexually transmitted diseases and how the diseases relate to health and hygiene. The multimedia presentation may be downloaded for later execution and the multimedia presentation may illustrate the progress through the presentation.

The education module used to describe troubled teen issues 2260 may include a multimedia presentation of troubled teen issues at different events and points in life and how the troubled teen issues relate to puberty, menstruation, and/or reproduction. The multimedia presentation may be downloaded for later execution and the multimedia presentation may illustrate the progress through the presentation.

The education module used to describe eating disorders 2265 further includes a multimedia presentation of eating disorders at different events and points in life and how the eating disorders relate to puberty, menstruation, and/or reproduction. The multimedia presentation may be downloaded for later execution and the multimedia presentation illustrates the progress through the presentation.

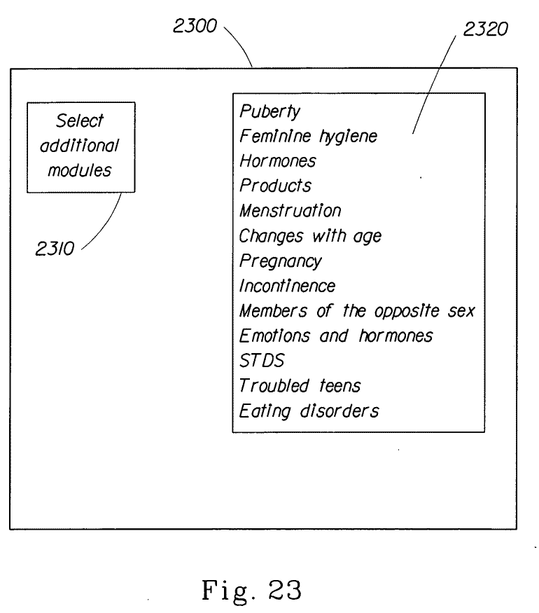

FIG. 23 illustrates a sample additional module user interface 2300. A supervisor may select the additional modules 2310 to be part of an education about puberty for a user. The modules selected 2320 may vary according to a variety of factors. The user interface 2300 may allow the supervisor to select additional modules 2320 or the user interface 2300 may allow the student to self select additional modules 2320 for viewing.

Each of these additional modules may require 3-dimensional illustrations to enhance the learning and retention of knowledge with students. These illustrations may be selected and rotated in three dimensions as previously demonstrated in FIGS. 2 and 3. In addition, instead of having to search multiple locations for the virtually infinite number of views, the views are available by merely rotating the illustration. The illustrations may be further highlighted with additional information. As a result, the user interfaces have a technical effect of saving a user a significant amount time and effort in typing and searching for views and information which is not available from a single source.

Further, the user interface and illustration may be used to teach additional topics related to puberty and health. For example, the illustration may be used to demonstrate how to minimize the risk of toxic shock syndrome or how to minimize the risk of becoming infected with sexually transmitted diseases. Logically, the illustrations may be used to illustrate the affects of sexually transmitted diseases or toxic shock syndrome. The user interface may also be used to illustrate how products are available to assist in avoiding sexually transmitted diseases or minimizing the risk of toxic shock syndrome.

Moreover, the various elements may be connected together in a variety of manners to create an educational lesson. For example, parts of the aging process illustration may be used to illustrate puberty. In some embodiments, elements may be available for use and administrators may create their own educational lessons based on the need of the students, local tolerance, etc.

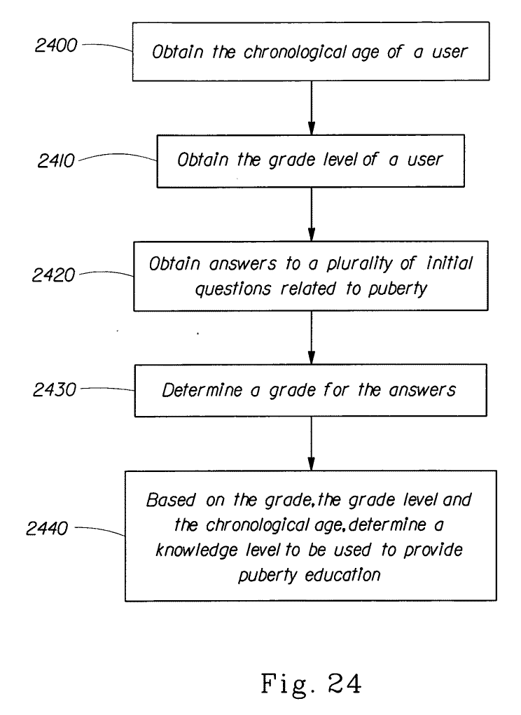

The education and illustrations may be designed with different audiences in mind. Logically, users with more knowledge should expect a different type of education that users with little or no knowledge. FIG. 24 may illustrate a method of creating a knowledge level for a user. At block 2400, the chronological age of a user may be obtained. The chronological age may be obtained in a variety of manners. The chronological age may be obtained by asking the user or may be obtained from a guardian or teacher. In addition, this information may be provided by an authority figure when names are provided during initial set up. Of course additional ways are possible and are contemplated.

At block 2410, the grade level of a user may be obtained. The grade level may be obtained by asking the user or may be obtained from a guardian or teacher. In addition, this information may be provided by an authority figure when names are provided during initial set up. Of course additional ways are possible and are contemplated.

At block 2420, answers to a plurality of initial questions related to puberty may be obtained. The questions may be related to the focus of the user interface presentation. The questions may be preset, may be randomly selected from a group of questions, or may be selected by a supervisor. Of course, other ways of selecting questions are possible and are contemplated. In another embodiment, the chronological age and the grade level are used to determine the initial questions where the initial questions are broken into groups based on age and grade level.

At block 2430, a grade for the answers may be determined. The answers provided are compared to the proper answers and a grade is created. The grade may a percentage that is correct, a placement within a group of classes or any other useful manner of separating the students by their knowledge.

At block 2440, based on the grade, the grade level and the chronological age, a knowledge level to be used to provide puberty education may be determined. The knowledge level of puberty may be used for the user to provide education to the user about puberty based on the determined knowledge level of the user. In other words, the education provided will be proper considering the knowledge of the user.

In another embodiment, additional questions may be provided to the user and, based on the ability to correctly answer the additional questions, further adjustments to the knowledge level used to provide the puberty education may be made. For example and not limitation, the users may memorize and share the answers to the initial questions. Additional questions may provide a better insight into the actual knowledge of a user.

In yet another embodiment, weights are applied to the chronological age, the grade level and the answer to the plurality of initial questions to determine the knowledge level of the user. The weights may be varied according to experience, by desire of the administrator or by any other reason. In one embodiment, if the grade level of a user is less than expected for a user of a given chronological age, or if the grade level of a user is greater than expected for a user of a given chronological ages, additional weight may be added to the grade level in determining the offset. In this way, development knowledge takes precedence over chronological age.

A predicted knowledge level may be calculated using the chronological age, the grade level of the user and the grade for the answers. The predicted knowledge level may be created using surveys of a statistically significant number of users where the chronological age and grade of the users are known and stored with the surveys. Special considerations may also be factored into the education program by the supervisor based on individual capabilities, or even learning disabilities. If the ability to correctly answer the additional questions is significantly below the predicted knowledge level, the knowledge level may be adjusted down. If the ability to correctly answer the additional questions is significantly above the predicted knowledge level, the knowledge level may be adjusted up.

Results of users' answers to additional questions may be stored at a central site along with the chronological age of the users and the grade level of the users to create a database of knowledge levels for users of different ages and grade levels. The database may be used to create the predicted knowledge level for a user.

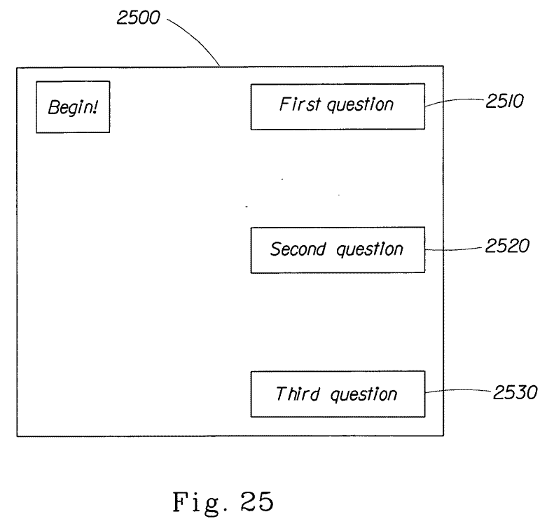

FIG. 25 may illustrate a user interface 2500 for obtaining information used to create a knowledge level for a user. A series of questions, 2510, 2520, 2530, etc. are provided to a user and a means of recording the responses are provided. The accuracy of the responses are determined and factored into the method of determining the knowledge level of the user previously described in FIG. 24.

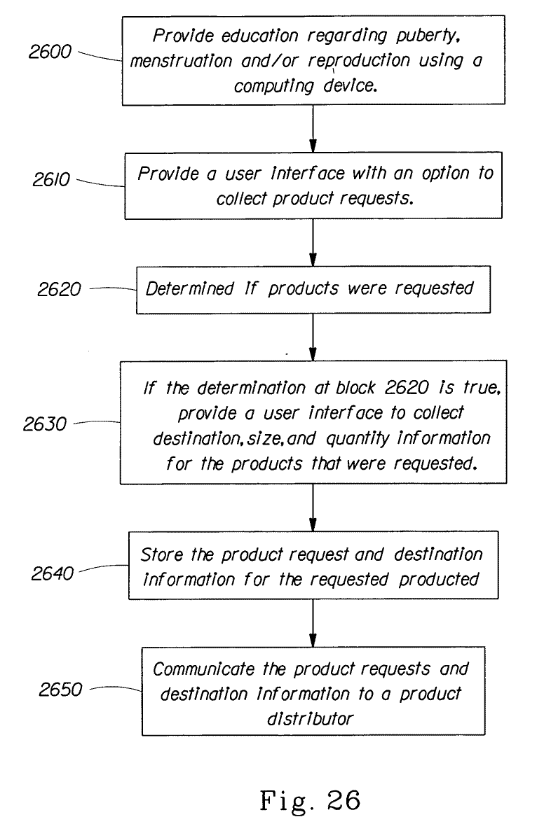

As part of the user interface, a user may be permitted to request samples of items, or order items for purchase. The user may be a supervisor, a student, or a parent. FIG. 26 may illustrate a method of supplying user with requested materials related to the education provided. At block 2600, education may be provided regarding puberty, menstruation, and/or reproduction using a computing device. As described previously, the education may cover many different aspects of growth and maturity.

At block 2610, a user interface may be provided with an option to collect product requests. The products that are offered may be related to the educational module presented. The product request may be for a sample product or may be for products for sale.

At block 2620, it may be determined if products were requested. This may be accomplished in a variety of ways such as whether a user selected to see more information about samples available or about products for sale. For example, a user may select to receive free samples and a list of available free samples may be displayed and another option may be to purchase products and a list of products available to be purchased may be listed.

At block 2630, if the determination at block 2620 is true, a user interface may be provided to collect destination, size, and quantity information for the products that were requested. As a variety of products may be available as samples or available for purchase, the relevant information to obtain the desired product may be collected.

At block 2640, the product request and destination information for the requested products may be stored. In one embodiment, the product requests and the destination information are stored in a database. Having the data in a database may provide a variety of advantages. In one embodiment, the database may be monitored to prevent fraudulent requests. For example, a user could repeatedly request samples and never actually pay for a product. By monitoring the database, such repeated attempts may be prevented. The database may also be used to create statistics related to the requested products. The statistics may include a most requested product, product with the greatest increase in requests, least requested product and product with the greatest reduction in requests. These statistics may then be used for marketing and sales purposes. For example, the products that are offered are adjusted based in the statistics.

At block 2650, the product requests and destination information may be communicated to a product distributor. The product distributor may be internal or external to the product manufacturer/seller. Products may be distributed based on the product requests and the destination information. Logically, a bill may be created by the distributor for the products that were sent to users.

In some embodiments, a follow-up message is communicated to the product requestor to determine the level of satisfaction with the requested products. Response to the follow-up message may be stored, added to a database and analyzed to provide additional data for the product creator. The follow-up message may include coupons for hygiene products, such as, for example, feminine hygiene products, deodorant, razors, shampoo, etc.

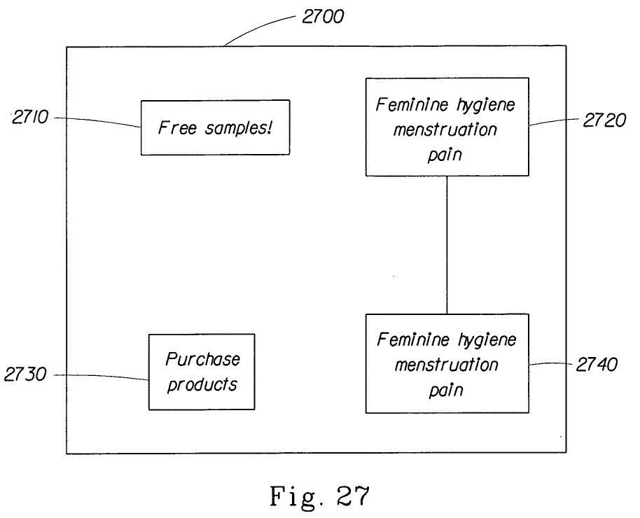

FIG. 27 is an illustration of one possible sample user interface 2700 for requesting products. The user may select information related to free samples 2710, products for purchase 2730. Upon selection of a product category, the user may then be provided with a list of products within that category and may subsequently select to receive more information on individual products, select a product for purchase 2740 or for the receiving of free product samples 2720.

The previous detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the invention have been illustrated and described, it would be obvious to those skilled in the art that various other changes and modifications can be made without departing from the scope of the invention. It is therefore intended to cover in the appended claims all such changes and modifications that are within the scope of this invention.

What is claimed is:

1. A user interface in communication with a computing device that illustrates at least a portion of human anatomy for educational purposes comprising:
creating an illustration of the anatomy that is in three dimensions wherein the illustration may be viewed in three dimensions;
displaying the illustration to demonstrate elements of the anatomy;
providing education content related to the illustration; and
allowing the illustration to be selected and rotated in three dimensions.

2. The user interface of claim 1, further comprising using the illustration to demonstrate the reproductive anatomy.

3. The user interface of claim 1, further comprising using the illustration to demonstrate one selected from a group comprising: a reproductive system, a pregnancy cycle and a female menstrual cycle.

4. The user interface of claim 1, further comprising using the illustration to demonstrate one selected from a group comprising: proper insertion of a tampon and proper absorbent pad placement.

5. The user interface of claim 1, further comprising using the illustration to demonstrate one selected from a group comprising: how to minimize the risk of toxic shock syndrome and how to minimize the risk of becoming infected with a sexually transmitted disease.

6. The user interface of claim 1, further comprising using the illustration to demonstrate changes in the anatomy during one selected from a group comprising puberty, a female reproductive cycle, and a female menstrual cycle.

7. The user interface of claim 6, further comprising allowing the selection of a point in time during one selected from a group comprising a female reproductive cycle and a female menstrual cycle to be displayed.

8. The user interface of claim 1, further comprising displaying additional options that may be selected related to the present display wherein the additional options are selected from a group comprising:
links to network locations of additional information;
links to additional narrative description;
links to additional video description; and
links download additional information.

9. The user interface of claim 1, further comprising providing written or narrative description of the anatomy during one selected from a group comprising: a female reproductive cycle, a female menstrual cycle; during puberty and during toxic shock syndrome.

10. The user interface of claim 1, further comprising providing written or narrative description of hygiene products, methods of using hygiene products, or a combination of products in a use system associated with the anatomy.

11. The user interface of claim 4, further comprising a user interface to request products.

12. A user interface in communication with a computing device for providing education about puberty comprising:
displaying a user interface that lists available educational modules related to puberty;
allowing a teacher, educator or supervisor to select the education modules to be part of an education about puberty for a user;
storing the selected educational modules in a memory in the computing device;
making the education modules available to the users; and
storing data related to the use of the modules by the users.

13. The user interface of claim 12, further comprising a user interface to allow the teacher, educator or supervisor to communicate an invitation to users to view the selected modules.

14. The user interface of claim 13, further comprising a user interface to allow the teacher, educator or supervisor to communicate a topics list and/or a glossary of anatomical terms used in the selected modules in an invitation to users.

15. The user interface of claim 12, further comprising a user interface to collect authorization from guardians of users such that the users may view the user interfaces.

16. The user interface of claim 15, further comprising a user interface to allow the teacher, educator or supervisor to communicate a topics list and/or glossary of anatomical terms used in the selected modules to guardians of users prior to collecting authorization from the guardians of the users.

17. The user interface of claim 12, further comprising selecting the modules related to puberty based on the policy of a governmental body.

18. The user interface of claim 12, further comprising a user interface to allow an administrator to load data into the computing device.

19. The user interface of claim 18, wherein the data comprises one selected from a group comprising: student log-in names, identification codes and modules for the student to review.

20. The user interface of claim 12, wherein the teacher, educator or supervisor receives reports about one selected from a group comprising progress of the users through the modules and user's grades on quizzes in the modules.

21. The user interface of claim 12, further comprising a user interface wherein the teacher, educator, supervisor and/or a program administrator may receive questions from users and may provide responses or wherein the program administrator may receive questions from the teacher educator and/or supervisor and may provide responses.

22. The user interface of claim 12, further comprising analyzing user grades on quizzes in the modules and determining modules that require additional emphasis based on the quiz grades.

23. The user interface of claim 12, wherein the reports comprise data on the users, data on the time spent on the modules, data on the correct answers to the quizzes in the modules and data on questions asked by the users.

24. The user interface of claim 12, wherein the modules are selected for an entire class.

25. The user interface of claim 12, wherein additional module may be added to specific members of a class.

26. A user interface in communication with a computing device that illustrates anatomy for educational purposes comprising:
providing a user interface for a user to provide a user name or identification code;
storing the user name or identification code;
determining if the user name or identification code is recognized;
if the user name or identification code is recognized;
storing data that the user has used the user interface;
retrieving stored data related to the user;
using the stored data to determine which user interface from a plurality of interfaces to display, wherein the displayed interface relates to the interface the user last used; and
if the user name or identification code is not recognized allowing the user to proceed as a guest or register as a new user.

27. The user interface of claim 26, further comprising determining a level of guardian permission for the user and displaying user interfaces that the user has guardian permission to view.

28. The user interface of claim 26, further comprising if the user is a new user, obtaining guardian information from the user such that permission to view additional interfaces may be obtained from the guardian.

29. The user interface of claim 26, further comprising displaying a user interface that allows a user to select what type of puberty education the user would desire to receive.

30. The user interface of claim 26, wherein if the user was directed to the user interface by a guardian, teacher, educator or supervisor, storing the progress of the user through user interfaces regarding puberty education and when the user ends the session, reporting the user progress to the guardian, teacher educator or supervisor.

31. The user interface of claim 30, wherein the report comprises a summary of the topics covered, the number of questions answered correctly and the time spent on each user interface.

32. The user interface of claim 27, wherein a guardian, teacher, educator or supervisor selects which user interfaces the user will be able to view.

33. The user interface of claim 26, wherein the user interface contains a chat bar wherein a user, guardian, teacher, educator and/or supervisor may submit questions or comments while viewing a user interface.

34. The user interface of claim 26, wherein the chat bar communicates the questions or comments to a network and wherein the question or comments may be responded to by a guardian, teacher, educator, supervisor, someone trained in puberty education or a program administrator.

35. The user interface of claim 26, wherein other users, teachers, educators, supervisors and/or a program administrator may view the same user interface at the same time.

36. The user interface of claim 35, wherein users, teachers, educators and/or supervisors may chat with each other and/or the program administrator in a chat bar on the user interface.

37. The user interface of claim 26, further comprising a user interface where the user may request sample products related to topics covered on the user interfaces viewed by the user.

38. The user interface of claim 26, further comprising a user interface where a user may select an education module to view.

39. The user interface of claim 26, further comprising a user interfaces that ask questions of users related to one selected from a group comprising a reproductive system, a menstrual cycle, an endocrine system, hygiene, toxic shock syndrome and sexually transmitted diseases and the answers to the questions are stored and graded.

40. The user interface of claim 39, wherein the answers and grades of the answers are communicated to a guardian, teacher, educator, supervisor or program administrator.

41. A user interface in communication with a computing device that illustrates anatomy in three dimensions for educational purposes comprising modules selected from a group of modules comprising:
a puberty education module to be used to describe body changes during puberty;
a hygiene module to be used to describe proper hygiene;
a sex education module to be used to describe sexual education;
a menstruation module to be used to describe body changes during menstruation;
an educational module to be used to describe body changes with age;
an educational module to be used to describe pregnancy;
an education module to be used to describe incontinence;
an educational module to be used to describe understanding members of the opposite sex;
an educational module to be used to describe emotions and hormones;
an educational module to be used to describe sexually transmitted diseases;
an educational module to be used to describe troubled teen issues; and
an educational module to be used to describe eating disorders.

42. The user interface of claim 41, wherein the education module used to describe body changes further comprises a multimedia presentation of different stages of body development over time and how the changes relate to puberty.

43. The user interface of claim 42, wherein the multimedia presentation may be downloaded for later execution and wherein the multimedia presentation illustrates the progress through the presentation.

44. The user interface of claim 41, wherein the education module used to describe pregnancy further comprises a multimedia presentation of different stages of body development while pregnant over time and how the changes relate to female reproduction.

45. The user interface of claim 44, wherein the multimedia presentation may be downloaded for later execution and wherein the multimedia presentation illustrates the progress during the presentation.

46. The user interface of claim 41, wherein the education module used to describe emotions and hormones further comprises a multimedia presentation of emotions and hormones at different events and points in life and how the emotions and hormones relate to a male reproductive system, a female reproductive system, a female menstrual cycle, pregnancy and/or an endocrine system.

47. The user interface of claim 46, wherein the multimedia presentation may be downloaded for later execution and wherein the multimedia presentation illustrates the progress through the presentation.

48. The user interface of claim 41, wherein the education module used to describe sexually transmitted diseases further comprises a multimedia presentation of sexually transmitted diseases and how the diseases relate to health and hygiene.

49. The user interface of claim 48, wherein the multimedia presentation may be downloaded for later execution and wherein the multimedia presentation illustrates the progress through the presentation.

50. The user interface of claim 41, wherein the education module used to describe emotions and hormones further comprises a multimedia presentation of emotions and hormones at different events and points in life and how the changes relate to puberty, reproduction, menstruation, and/or maturation.

51. The user interface of claim 50, wherein the multimedia presentation may be downloaded for later execution and wherein the multimedia presentation illustrates the progress through the presentation.

52. The user interface of claim 41, wherein the education module used to describe troubled teen issues further comprises a multimedia presentation of troubled teen issues at different events and points in life and how the troubled teen issues relate to puberty, maturation, menstruation, and/or reproduction, and wherein the multimedia presentation may be downloaded for later execution, and wherein the multimedia presentation illustrates the progress through the presentation.

53. The user interface of claim 41, wherein the education module used to describe emotions and hormones further comprises a multimedia presentation of emotions and hormones at different events and points in life and how emotions and hormones relate to puberty, menstruation, and/or reproduction, and
wherein the multimedia presentation may be downloaded for later execution, and
wherein the multimedia presentation illustrates the progress through the presentation.

54. The user interface of claim 41, wherein the education module used to describe eating disorders further comprises a multimedia presentation of eating disorders at different events and points in life and how the eating disorders relate to puberty, maturation, menstruation, and/or reproduction, and
wherein the multimedia presentation may be downloaded for later execution, and
wherein the multimedia presentation illustrates the progress through the presentation.

55. The user interface of claim 41, wherein the education module used to describe understanding members of the opposite sex further comprises a multimedia presentation of understanding members of the opposite sex at different events and points in life and how understanding members of the opposite sex relates to puberty, maturation, menstruation, and/or reproduction, and
wherein the multimedia presentation may be downloaded for later execution, and
wherein the multimedia presentation illustrates the progress through the presentation.

56. A user interface in communication with a computing device that illustrates anatomy for educational purposes comprising:
providing education regarding the puberty, maturation, menstruation, and/or reproduction using the computing device;
providing a user interface with an option to collect product requests;
if products were requested, providing a user interface to collect destination, size, and quantity information for the products that were requested;
storing the product request and destination information; and
communicating the product requests and destination information to a product distributor.

57. The user interface of claim 56, further comprising distributing products based on the product requests and the destination information.

58. The user interface of claim 57, further comprising creating a bill related to the distributed products.

59. The user interface of claim 57, further comprising storing the product requests and the destination information in a database.

60. The user interface of claim 59, further comprising monitoring the database to prevent fraudulent requests.

61. The user interface of claim 56, wherein a follow-up message is communicated to determine the level of satisfaction with the requested products and/or the education provided.

62. The user interface of claim 56, wherein a follow-up message is communicated to direct consumers to store locations carrying products associated with male or feminine hygiene.

63. The user interface of claim 56, wherein a follow-up message is communicated to direct consumers to websites containing information on product selection.

64. The user interface of claim 56, wherein a follow-up message includes coupons for hygiene products.

65. The user interface of claim 59, wherein the database is used to created statistics related to requested products.

66. The user interface of claim 65, wherein the statistics comprise most requested product, product with the greatest increase in requests, least requested product and product with the greatest reduction in requests.

67. The user interface of claim 65, wherein the products that are offered are adjusted based in the statistics.

68. The user interface of claim 56, further comprising offering products that are related to the educational module.

69. The user interface of claim 56, wherein product request is for a sample product.

70. The user interface of claim 56, further comprising offering products for sale.

71. A method of determining a level of education related to puberty using a computing based device comprising:
obtaining the chronological age of a user;
obtaining the grade level of a user;
obtaining answers to a plurality of initial questions related to female puberty;
determining a grade for the answers; and
based on the grade, the grade level and the chronological age, determining a knowledge level to be used to provide puberty education.

72. The method of claim 71, further comprising using the knowledge level of puberty for the user to providing education to the user about female puberty based on the determined knowledge level of the user.

73. The method of claim 72, further comprising using the chronological age the grade level to determine the initial questions where the initial questions are broken into groups based on age and grade level.

74. The method of claim 72, further comprising providing additional questions to the user and, based on the ability to correctly answer the additional questions, further adjusting the knowledge level used to provide the puberty education.

75. The method of claim 72, wherein weights are applied to the chronological age, the grade level and the answer to the plurality of initial questions to determine the knowledge level of the user.

76. The method of claim 72, further comprising:
if the grade level of a user is less than expected for a user of a given chronological age, or if the grade level of a user is greater than expected for a user of a given chronological ages, adding additional weight to the grade level in determining the offset.

77. The method of claim 74, further comprising calculating a predicted knowledge level using the chronological age, the grade level of the user and the grade for the answers and
if the ability to correctly answer the additional questions is significantly below the predicted knowledge level, adjusting the knowledge level down, and
if the ability to correctly answer the additional questions is significantly above the predicted knowledge level, adjusting the knowledge level up.

78. The method of claim 77, wherein the predicted knowledge level is created using surveys of a statistically significant number of users where the chronological age and grade of the users are known and stored with the surveys.

79. The method of claim 77, wherein results of users' answers to additional questions are stored at a central site along with the chronological age of the users and the grade level of the users to create a database of knowledge levels for users of different ages and grade levels.

80. The method of claim 79, wherein the database is used to create the predicted knowledge level for a user.

81. A computer based user interface comprising three dimensional illustration of anatomy comprising:
an illustration of relevant elements of the anatomy where the illustration may be rotated along three axes;
if an element is selected, displaying an option to display an expanded view of the selected element of the anatomy in three dimensions where the element may be rotated along three axes;
if an element is selected, displaying an option to display additional information related to a selected element of the anatomy; and
a user interface that illustrates changes in the anatomy during puberty, a female reproductive cycle, pregnancy and/or a menstrual cycle.

82. The computer based user interface of claim 81, further comprising displaying a progress indication related to the progression through the female reproductive cycle, the menstrual cycle, and/or puberty.

83. The computer based user interface of claim 81, wherein the progression can be stopped at a point in time and additional information may be obtained about a reproductive system, pregnancy, a menstrual cycle, and/or puberty at the stopped point in time.

84. The computer based user interface of claim 81, wherein to display additional information related to a selected element of a reproductive system further comprising displaying a name of the selected element, a description of the biological function of the selected element and a description of the purpose of the selected element in the reproductive system, pregnancy, menstrual cycle, and/or puberty.

85. The computer based user interface of claim 81, wherein if the option to display an expanded view of the selected element of a reproductive system in three dimensions where the element may be rotated along three axes is selected, the user interface displays an additional window in which the selected element is illustrated in three dimensions and may be rotated on three axes.

86. The computer based user interface of claim 81, wherein the illustration may be selected by a user and the user may rotate the illustration along three axes.

87. The computer based user interface of claim 86, wherein the selected element may be viewed changing during puberty, pregnancy, the female reproductive cycle, and/or the menstrual cycle.

88. The computer based user interface of claim 81, wherein elements of the illustration are highlighted as the illustration progress to illustrate the changes during the female reproductive cycle, pregnancy, the menstrual cycle, and/or puberty.

89. The computer based user interface of claim 81, wherein the illustration illustrates one selected from a group comprising changes to reproductive anatomy during pregnancy; affects of toxic shock syndrome on the female anatomy; affect of emotions and hormones on the anatomy; and how hygiene products assist users.

90. A user interface in communication with a computing device that illustrates anatomy for educational purposes comprising:
creating an initial illustration of reproductive anatomy in three dimensions wherein if an element of the illustration is selected, performing at least one from a group comprising:
displaying additional information about the selected element;
expanding the view of the selected element;
allowing the element of be viewed separately and rotated in three dimensions such that the element may be viewed from a plurality of angles;
displaying video content related to the selected element;
executing audio files containing content related to the selected element; and
displaying an option to link to additional information about the selected element;
if the element of the illustration is unselected, displaying the initial illustration.

91. The user interface of claim 90, further comprising displaying an option to download a file about the element selected where the file may be downloaded and stored for later execution.

92. The user interface of claim 91, wherein the file is one selected from a group comprising a video file, a text file, an audio file and an animation file.

93. The user interface of claim 90, further comprising displaying an option to print additional information about the selected element.

94. The user interface of claim 90, wherein the additional information about the selected element illustrates a function of the selected element in one selected from a group comprising a reproductive system, pregnancy; a female menstrual cycle and a female endocrine system.

95. The user interface of claim 90, wherein the links to additional information link to hygiene product supplier network sites.

96. The user interface of claim 95, where the links are to hygiene products related to the element selected.

97. The user interface of claim 90, wherein expanding the view of the selected element further comprises creating an overlay user interface where a larger and more detailed version of the selected element is displayed in the overlay.

98. The user interface of claim 90, wherein allowing the element in the overlay viewed separately and rotated in three dimensions such that the element may be viewed from a plurality of angles further comprises allowing a user to select to rotate and stop the rotation of the element using an input device.

99. The user interface of claim 90, wherein displaying video content related to the selected element further comprises executing a video display that illustrates one or more roles that the element has in a reproductive system.

100. The user interface of claim 90, wherein displaying video content related to the selected element further comprises allowing the video to be at least one selected from a group comprising stopped, paused, skipped, fast forwarded and rewound.

101. The user interface of claim 90, wherein displaying video content related to the selected element further comprises displaying a progress indicator that indicates progress through the video content.

102. The user interface of claim 90, wherein a user signs in and progress of the user is stored such that when the user returns to the in return to the user interface, the user returns to the location at which the user left the user interface.

103. The user interface of claim 90, wherein executing audio files containing content related to the selected element further comprises allowing the audio file to be at least one selected from a group comprising stopped, paused, skipped, fast forwarded and rewound and wherein executing audio content related to the selected element further comprises displaying a progress indicator that indicates progress through the audio content.
